(19) United States
(12) Patent Application Publication
(10) Pub. No.: US 2018/0330679 A1
(43) Pub. Date: Nov. 15, 2018

(54) LIQUID CRYSTAL DISPLAY PANEL AND DEVICE

(71) Applicant: Shenzhen China Star Optoelectronics Semiconductor Display Technolgy Co., Ltd., Guangdong (CN)

(72) Inventor: Sikun HAO, Guangdong (CN)

(21) Appl. No.: 15/577,943

(22) PCT Filed: Jun. 9, 2017
(86) PCT No.: PCT/CN2017/087793

§ 371 Date: Nov. 29, 2017

(30) Foreign Application Priority Data
May 10, 2017 (CN) 201710326404.3

(51) Int. Cl. G09G 3/36

(52) U.S. Cl. CPC G09G 3/3607; G09G 3/3611; G09G 2320/0242; G09G 2310/06; G09G 2330/02; G09G 2300/0452

(57) ABSTRACT

A liquid crystal display panel and device are provided. The panel includes N-numbered data lines, a plurality of scan lines, and a plurality of pixels, wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels.

### FIELD OF THE INVENTION

The present disclosure relates to a technical field of displays, and more particularly to a liquid crystal display panel and device.

### BACKGROUND OF THE INVENTION

Liquid crystal displays are currently one type of flat panel displays that are widely used, and are used in various electronic apparatuses, such as mobile phones, personal digital assistants (PDAs), digital cameras, computer screens, and laptop computer screens.

Currently, liquid crystal displays that are popularly adopted, generally consist of upper and lower substrates and a liquid crystal layer, wherein the substrates consist of glass and electrodes, etc. When the electrodes are correspondingly disposed in both of the upper and lower substrates, a display in a vertical electric field mode is formed, such as a Twist Nematic (TN) mode, a Vertical Alignment (VA) mode, and a Multi-domain Vertical Alignment (MVA) mode, which was developed for solving narrow viewing angles. When the electrodes are disposed in only one of the substrates, a display in a horizontal electric field mode is formed, such as an In-plane Switching (IPS) mode and a Fringe Field Switching (FFS) mode.

FIG. 1 and FIG. 2 are two types of driving structures that are frequently used by existing liquid crystal displays, wherein 101-103 are correspondingly red, green, and blue pixels, G1-G6 represent scan lines, and D1-D6 represent data lines. When FIG. 2 is compared to FIG. 1, the number of the data lines in a second type of driving structure is ⅓ of the number of the data lines in a first type of driving structure. Therefore, the number of data connectors (i.e. data COFs) in the second type of driving structure is ⅓ of the number of data connectors in the first type of driving structure, the number of the scan lines in the second type of driving structure is 3 times of the number of the scan lines in the first type of driving structure, and a pulse width and a charging time of each scan signal of the second type of driving structure is ⅓ of a pulse width and a charging time of each scan signal of the first type of driving structure.

FIG. 3 is a schematic diagram of the second type of driving structure displaying a frame having a single color. When the frame having the single color is displayed, only data voltages corresponding to the green pixels are configured as high voltage levels, and data voltages corresponding to the red and the blue pixels are configured as low voltage levels. That is, the green pixels display a green color, and the red and the blue pixels display a completely black color. Taking a first column of pixels as an example, a waveform of a driving signal of the first column of pixels is illustrated in FIG. 4, wherein t1-t2, and t4-t5 correspondingly represent data voltages of a first and a second red pixel in the first column, t2-t3 and t5-t6 correspondingly represent data voltages of a first and a second green pixel in the first column, and t3-t4 and t6-t7 correspondingly represent data voltages of a first and a second blue pixel in the first column. FIG. 4 only provides a driving waveform of one column of pixels, wherein 11 represents data voltages provided externally, i.e. initial data voltages, and 12 represents actual data voltages. Because a data voltage on the data line have been in a state of varying between high and low levels, an overloaded frame appears, and charging capabilities of the pixel worsen, thereby easily causing charging to be insufficient, thereby leading to poorly displayed frames and lowered display quality.

Therefore, it is desired to provide a liquid crystal display panel and device to solve the problem exists in the related art.

### SUMMARY OF THE INVENTION

An object of the present disclosure is to provide a liquid crystal display panel and device to raise display quality.

In order to solve the aforementioned problem, the present disclosure provides a liquid crystal display panel that includes:

N-numbered data lines, a plurality of scan lines, and a plurality of pixels, wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, and the (n+1)th data line successively drives two of the plurality of pixels having the same color; and wherein when the liquid crystal display panel displays a frame having a single color, data voltages of the pixels in each column of the plurality of pixels having the same color are configured as a high voltage level, wherein N≤2, and 0<n<N.

In the liquid crystal display panel of the present disclosure, the (n+1)th data line is connected to even rows of an (n+1)th column of the plurality of pixels, and is connected to odd rows of the nth column of the plurality of pixels.

In the liquid crystal display panel of the present disclosure, the (n+1)th data line is connected to odd rows of an (n+1)th column of the plurality of pixels, and is connected to even rows of the nth column of the plurality of pixels.

In the liquid crystal display panel of the present disclosure, the (n+1)th data line successively drives the two of the plurality of pixels having the same color correspondingly in the nth column of the plurality of pixels and an (n+1)th column of the plurality of pixels.

In the liquid crystal display panel of the present disclosure, the two of the plurality of pixels having the same color are correspondingly located in two rows of the plurality of pixels adjacent to each other.

In order to solve the aforementioned problem, the present disclosure provides a liquid crystal display panel that includes:

N-numbered data lines, a plurality of scan lines, and a plurality of pixels, wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, wherein N≥2, and 0<n<N.

In the liquid crystal display panel of the present disclosure, the (n+1)th data line is connected to even rows of an (n+1)th column of the plurality of pixels, and is connected to odd rows of the nth column of the plurality of pixels.

In the liquid crystal display panel of the present disclosure, the (n+1)th data line is connected to odd rows of an (n+1)th column of the plurality of pixels, and is connected to even rows of the nth column of the plurality of pixels.

In the liquid crystal display panel of the present disclosure, the (n+1)th data line successively drives two of the plurality of pixels having the same color.

In the liquid crystal display panel of the present disclosure, the (n+1)th data line successively drives the two of the plurality of pixels having the same color correspondingly in the nth column of the plurality of pixels and an (n+1)th column of the plurality of pixels.

In the liquid crystal display panel of the present disclosure, the two of the plurality of pixels having the same color are correspondingly located in two rows of the plurality of pixels adjacent to each other.

In the liquid crystal display panel of the present disclosure, when the liquid crystal display panel displays a frame having a single color, data voltages of the pixels in each column of the plurality of pixels having the same color are configured as a high voltage level.

The present disclosure still provides a liquid crystal display device which includes:

a backlight module; and

a liquid crystal display panel, including:

N-numbered data lines, a plurality of scan lines, and a plurality of pixels, wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, wherein N≥2, and 0<n<N.

In the liquid crystal display device of the present disclosure, the (n+1)th data line is connected to even rows of an (n+1)th column of the plurality of pixels, and is connected to odd rows of the nth column of the plurality of pixels.

In the liquid crystal display device of the present disclosure, the (n+1)th data line is connected to odd rows of an (n+1)th column of the plurality of pixels, and is connected to even rows of the nth column of the plurality of pixels.

In the liquid crystal display device of the present disclosure, the (n+1)th data line successively drives two of the plurality of pixels having the same color.

In the liquid crystal display device of the present disclosure, the (n+1)th data line successively drives the two of the plurality of pixels having the same color correspondingly in the nth column of the plurality of pixels and an (n+1)th column of the plurality of pixels.

In the liquid crystal display device of the present disclosure, the two of the plurality of pixels having the same color are correspondingly located in two rows of the plurality of pixels adjacent to each other.

In the liquid crystal display device of the present disclosure, when the liquid crystal display panel displays a frame having a single color, data voltages of the pixels in each column of the plurality of pixels having the same color are configured as a high voltage level.

For the liquid crystal display panel and the device of the present disclosure, because each data line alternately drives two corresponding columns of pixels, when a frame having a single color is displayed, the data line successively drives two pixels having the same color, causing a second pixel to change from being overloaded to being lightly loaded, increasing a charging capability of the second pixel, lowering power consumption of a source driving chip, and raising display quality of the liquid crystal display panel.

### DESCRIPTION OF THE DRAWINGS

FIG. 1 is a diagram of a first type of driving structure of existing liquid crystal displays.

FIG. 2 is a diagram of a second type of driving structure of existing liquid crystal displays.

FIG. 3 is a schematic diagram of the liquid crystal display panel in FIG. 2 displaying a frame having a single color.

FIG. 4 is a waveform diagram of a data signal of a column of pixels.

FIG. 5 is a diagram of a driving structure of a liquid crystal display panel of the present disclosure.

FIG. 6 is a waveform diagram of driving signals corresponding to FIG. 5.

FIG. 7 is a schematic diagram of the liquid crystal display panel in FIG. 5 displaying a frame having a single color.

FIG. 8 is a waveform diagram of driving signals corresponding to FIG. 7.

FIG. 9 is a waveform diagram of a data signal of a column of pixels in a purely green frame.

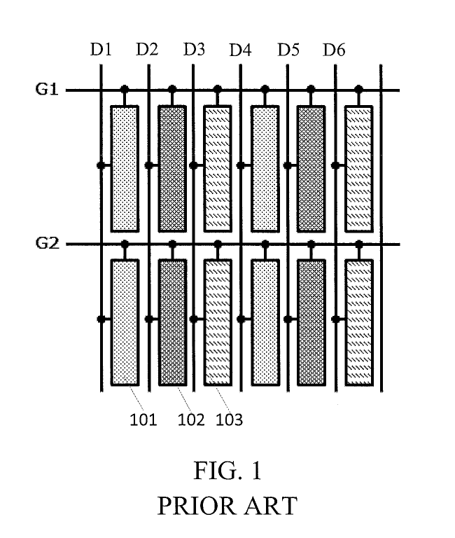

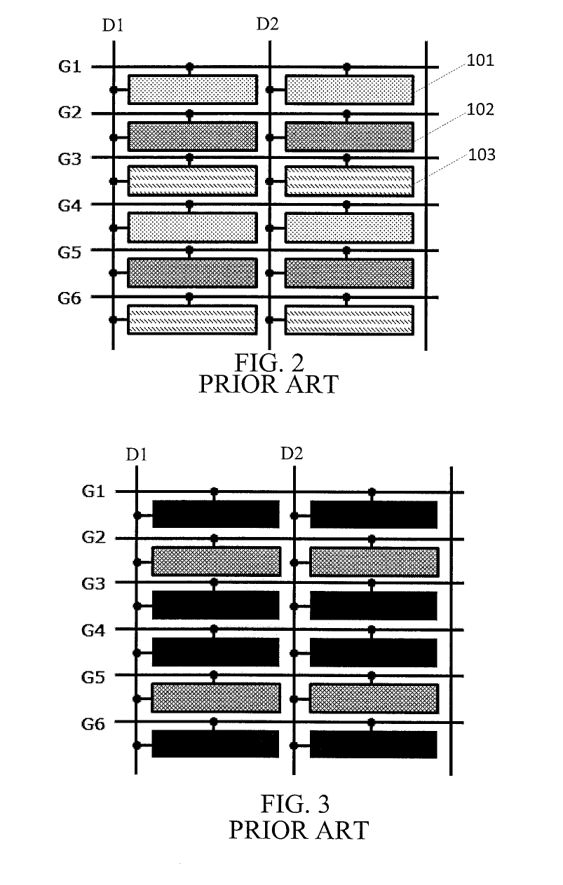

### DETAILED DESCRIPTION OF THE PREFERRED EMBODIMENTS

Description of each embodiment below refers to respective accompanying drawing(s), so as to exemplarily illustrate specific embodiments of the present disclosure that may be practiced. Directional terms mentioned in the present disclosure, such as “upper”, “lower”, “front”, “back”, “left”, “right”, “inner”, “outer”, “side”, etc., are only directions by referring to the accompanying drawings, and thus the used directional terms are used to describe and understand the present disclosure, but the present disclosure is not limited thereto. In the drawings, structurally similar units are labeled by the same reference numerals.

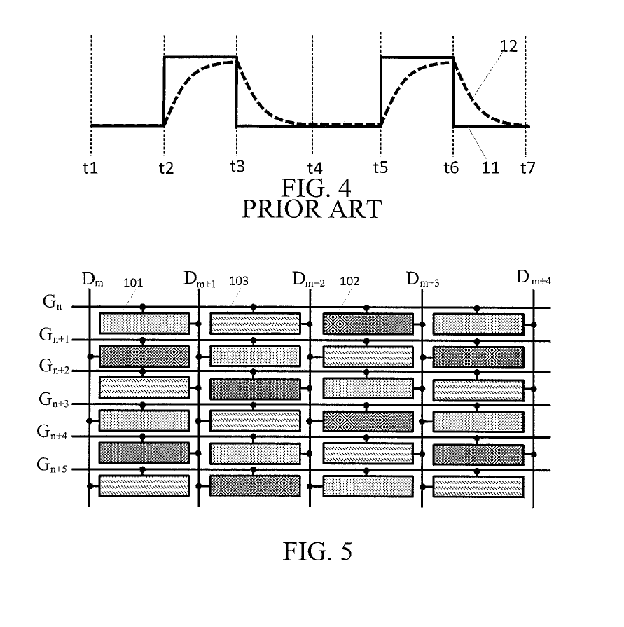

Referring FIGS. 5 to 8, FIG. 5 is a diagram of a driving structure of a liquid crystal display panel of the present disclosure.

As illustrated in FIG. 5, a liquid crystal display panel of a present embodiment includes a plurality of scan lines Gn to Gn+5, a plurality of data lines Dm to Dm+4, and a plurality of pixels. The plurality of pixels include a red pixel 101, a green pixel 102, and a blue pixel 103. Two of the plurality of pixels adjacent to each other have different colors. Specifically, two of the plurality of pixels adjacent to each other and located in a same row or a same column have different colors. That is, RGB pixels are distributed in a staggered manner. A first column of the plurality of pixels are arranged in an order of RGBRGB, a second column of the plurality of pixels are arranged in an order of BRGBRG and a third column of the plurality of pixels are arranged in an order of GBRGBR.

The plurality of pixels form a pixel array. Each of the plurality of scan lines is correspondingly disposed in each row of the plurality of pixels. That is, the number of the plurality of scan lines is equal to the number of rows of the plurality of pixels. An nth column of the plurality of pixels corresponds to an nth data line and an (n+1)th data line, the nth data line and the (n+1)th data line are alternately connected to each pixel in the nth column of the plurality of pixels, wherein N≥2, and 0<n<N. That is, the nth data line and the (n+1)th data line are alternately connected to pixels located in different rows in the nth column of the plurality of pixels. The first column of the plurality of pixels is correspondingly connected to a first data line Dm and a second data line Dm+1. The first data line Dm and the second data line Dm+1 are alternately connected to pixels in the first column of the plurality of pixels.

In one embodiment, the (n+1)th data line is connected to even rows of an (n+1)th column of the plurality of pixels, and is connected to odd rows of the nth column of the plurality of pixels. For example, as illustrated in FIG. 5, the second data line Dm+1 is connected to odd rows of the first column of the plurality of pixels, and is connected to even rows of the second column of the plurality of pixels.

Further, the (n+1)th data line successively drives two of the plurality of pixels having the same color, wherein the (n+1)th data line successively drives the two of the plurality of pixels having the same color correspondingly in the nth column of the plurality of pixels and an (n+1)th column of the plurality of pixels.

For each of the plurality of data lines, the (n+1)th data line orderly drives a pixel having a first color located in the nth column and a pixel having the first color located in the (n+1)th column, a pixel having a second color located in the nth column and a pixel having the second color located in the (n+1)th column, and a pixel having a third color located in the nth column and a pixel having the third color located in the (n+1)th column. The first color is red, for example. The second color is blue, for example. The third color is green, for example.

For example, the second data line Dm+1 successively drives a red pixel located in the first column and a red pixel located in the second column, then successively drives a blue pixel located in the first column and a blue pixel located in the second column, and then successively drives a green pixel located in the first column and a green pixel located in the second column.

That is, each of the plurality of data lines alternately connects two corresponding columns of the plurality of pixels on the left and right. Take each column of the plurality of pixels including two pixel units as an example. Each pixel unit includes 3 pixels, i.e. red, green, and blue pixels. Take the second data line Dm+1 as an example. The second data line Dm+1 first drives two red pixels R11, R22, then drives two blue pixels B31, B42, and then drives two green pixels G51, G62, wherein 11, 22, 31, 42, 51, 62 represent locations of the pixels in the array. A number in the first place represents a row in which a pixel is located, and a number in the second place represents a column in which the pixel is located. For example, 11 represents the pixel in the first row and the first column.

The two of the plurality of pixels having the same color correspondingly in the nth column of the plurality of pixels and the (n+1)th column of the plurality of pixels are correspondingly located in two rows of the plurality of pixels adjacent to each other. The two pixels having the first color are located in two rows adjacent to each other, the two pixels having the second color are located in two rows adjacent to each other, the two pixels having the third color are located in two rows adjacent to each other. For example, the red pixel R11 located in the first column and the red pixel R22 located in the second column are correspondingly located in a first row and a second row. The two blue pixels B31, B42 are located in a third row and a fourth row. The two green pixels G51, G62 are located in a fifth row and a sixth row.

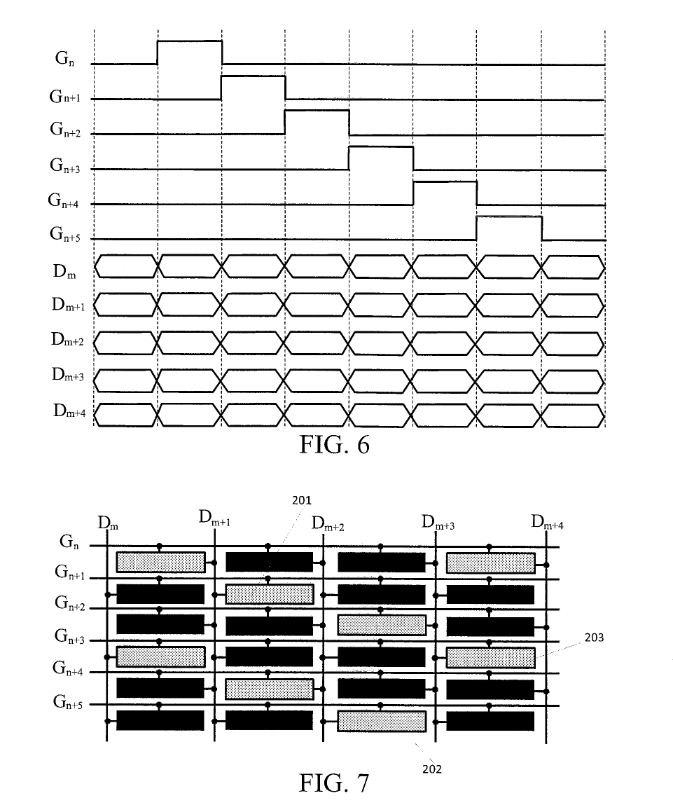

As illustrated in FIG. 6, a waveform diagram of driving signals corresponding to FIG. 5 is provided. Gn to Gn+5 represent waveforms of signals on a first to a sixth scan line, and Dm to Dm+4 represent waveforms of signals on a first to a fifth data line. A signal on each data line alternates between positive and negative levels.

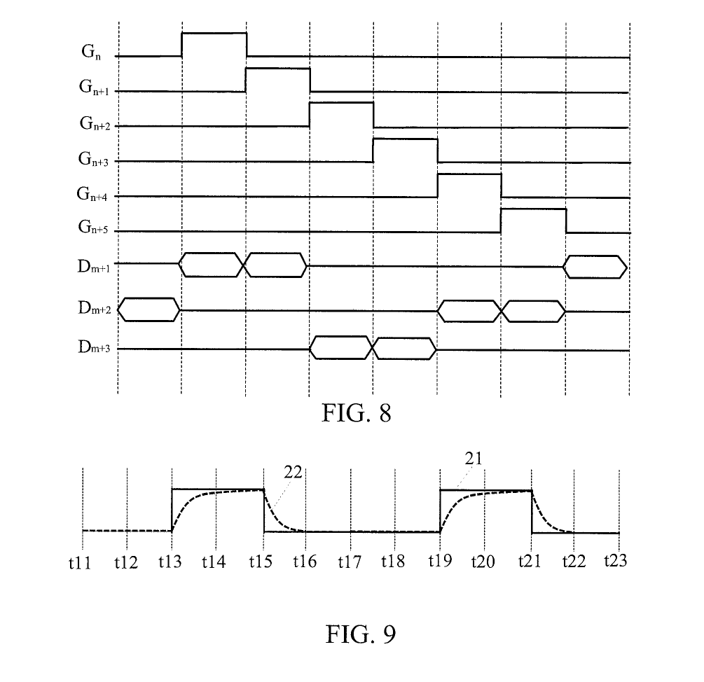

FIG. 7 is a schematic diagram of the structure of the display panel illustrated in FIG. 5 displaying a purely red frame. At this time, green and blue pixels are in a state of displaying a completely black color. As shown in the figure, a second red pixel 201 to 203 corresponding to each data line changes from being overloaded to being lightly loaded. In combination with FIG. 8, Gn to Gn+5 represent waveforms of signals on a first to a sixth scan line, Dm+1 to Dm+3 represent waveforms of signals on a second to a fourth data line. Because a data voltage of a first red pixel corresponding to each data line is configured as a high voltage level, and a data voltage of the second red pixel is also configured as the high voltage level, the voltage level of the data voltage of the second red pixel is the same as the voltage level of the data voltage of a previous pixel. Therefore, the pixel is lightly loaded driven. That is, among data voltages on the data line, the data voltage on the second pixel does not vary between high and low levels. The so called “lightly loaded driven” means a data voltage does not vary between high and low levels. Therefore, a charging capability of the second pixel is increased, and display quality of the liquid crystal display panel is further raised.

FIG. 9 is a driving waveform of a purely green frame. Taking a third data line Dm+2 having 12 pixels thereon as an example, t11 to t13 correspondingly represent data voltages of a first and a second blue pixel along the third data line, t13 to t15, correspondingly represent data voltages of a first and a second green pixel in the column, t15 to t17 correspondingly represent data voltages of a first and a second red pixel in the column, t17 to t19 correspondingly represent data voltages of a third and a fourth blue pixel along the third data line, t19 to t21 correspondingly represent data voltages of a third and a fourth green pixel in the column, and t21 to t23 correspondingly represent data voltages of a third and a fourth red pixel in the column.

FIG. 9 only provides a driving waveform of one column of the plurality of pixels, wherein 21 represents data voltages provided externally, i.e. initial data voltages, and 22 represents actual data voltages. Because the voltage of the second green pixel on the data line is not in a state of varying between high and low voltage levels, the second green pixel is lightly loaded driven. That is, with respect to FIG. 4, the second pixel being overloaded driven is changed to being lightly loaded driven. Therefore, a charging capability of the second pixel is increased, and display quality of the liquid crystal display panel is further raised. It can be appreciated that a waveform of a driving signal of the blue pixels is similar to that of the green pixels and the description is omitted here.

It can be appreciated that in another embodiment, the (n+1)th data line is connected to odd rows of an (n+1)th column of the plurality of pixels, and is connected to even rows of the nth column of the plurality of pixels.

The present disclosure further provides a liquid crystal display device, which includes a backlight module and a liquid crystal display panel. The liquid crystal display panel includes a plurality of scan lines Gn to Gn+5, a plurality of data lines D m to Dm+4, and a plurality of pixels. The plurality of pixels include a red pixel 101, a green pixel 102, and a blue pixel 103. Two of the plurality of pixels adjacent to each other have different colors. Specifically, two of the plurality of pixels adjacent to each other and located in a same row or a same column have different colors. That is, RGB pixels are distributed in a staggered manner. A first column of the plurality of pixels are arranged in an order of RGBRGB, a second column of the plurality of pixels are arranged in an order of BRGBRG and a third column of the plurality of pixels are arranged in an order of GBRGBR.

The plurality of pixels form a pixel array. Each of the plurality of scan lines is correspondingly disposed in each row of the plurality of pixels. That is, the number of the plurality of scan lines is equal to the number of rows of the plurality of pixels. An nth column of the plurality of pixels corresponds to an nth data line and an (n+1)th data line, the nth data line and the (n+1)th data line are alternately connected to each pixel in the nth column of the plurality of pixels, wherein N≥2, and 0<n<N. That is, the nth data line and the (n+1)th data line are alternately connected to pixels located in different rows in the nth column of the plurality of pixels. The first column of the plurality of pixels is correspondingly connected to a first data line Dm and a second data line Dm+1. The first data line Dm and the second data line Dm+1 are alternately connected to pixels in the first column of the plurality of pixels.

In one embodiment, the (n+1)th data line is connected to even rows of an (n+1)th column of the plurality of pixels, and is connected to odd rows of the nth column of the plurality of pixels. For example, as illustrated in FIG. 5, the second data line Dm+1 is connected to odd rows of the first column of the plurality of pixels, and is connected to even rows of the second column of the plurality of pixels.

Further, the (n+1)th data line successively drives two of the plurality of pixels having the same color, wherein the (n+1)th data line successively drives the two of the plurality of pixels having the same color correspondingly in the nth column of the plurality of pixels and an (n+1)th column of the plurality of pixels.

For each of the plurality of data lines, the (n+1)th data line orderly drives a pixel having a first color located in the nth column and a pixel having the first color located in the (n+1)th column, a pixel having a second color located in the nth column and a pixel having the second color located in the (n+1)th column, and a pixel having a third color located in the nth column and a pixel having the third color located in the (n+1)th column. The first color is red, for example. The second color is blue, for example. The third color is green, for example.

For example, the second data line Dm+1 successively drives a red pixel located in the first column and a red pixel located in the second column, then successively drives a blue pixel located in the first column and a blue pixel located in the second column, and then successively drives a green pixel located in the first column and a green pixel located in the second column.

That is, each of the plurality of data lines alternately connects two corresponding columns of the plurality of pixels on the left and right. Take each column of the plurality of pixels including two pixel units as an example. Each pixel unit includes 3 pixels, i.e. red, green, and blue pixels. Take the second data line Dm+1 as an example. The second data line Dm+1 first drives two red pixels R11, R22, then drives two blue pixels B31, B42, and then drives two green pixels G51, G62, wherein 11, 22, 31, 42, 51, 62 represent locations of the pixels in the array. A number in the first place represents a row in which a pixel is located, and a number in the second place represents a column in which the pixel is located. For example, 11 represents the pixel in the first row and the first column.

The two of the plurality of pixels having the same color correspondingly in the nth column of the plurality of pixels and the (n+1)th column of the plurality of pixels are correspondingly located in two rows of the plurality of pixels adjacent to each other. The two pixels having the first color are located in two rows adjacent to each other, the two pixels having the second color are located in two rows adjacent to each other, the two pixels having the third color are located in two rows adjacent to each other. For example, the red pixel R11 located in the first column and the red pixel R22 located in the second column are correspondingly located in a first row and a second row. The two blue pixels B31, B42 are located in a third row and a fourth row. The two green pixels G51, G62 are located in a fifth row and a sixth row.

As illustrated in FIG. 6, a waveform diagram of driving signals corresponding to FIG. 5 is provided. Gn to Gn+5 represent waveforms of signals on a first to a sixth scan line, and Dm to Dm+4 represent waveforms of signals on a first to a fifth data line. A signal on each data line alternates between positive and negative levels.

FIG. 7 is a schematic diagram of the structure of the display panel illustrated in FIG. 5 displaying a purely red frame. At this time, green and blue pixels are in a state of displaying a completely black color. As shown in the figure, a second red pixel 201 to 203 corresponding to each data line changes from being overloaded to being lightly loaded. In combination with FIG. 8, Gn to Gn+5 represent waveforms of signals on a first to a sixth scan line, Dm+1 to Dm+3 represent waveforms of signals on a second to a fourth data line. Because a data voltage of a first red pixel corresponding to each data line is configured as a high voltage level, and a data voltage of the second red pixel is also configured as the high voltage level, the voltage level of the data voltage of the second red pixel is the same as the voltage level of the data voltage of a previous pixel. Therefore, the pixel is lightly loaded driven. That is, among data voltages on the data line, the data voltage on the second pixel does not vary between high and low levels. The so called “lightly loaded driven” means a data voltage does not vary between high and low levels. Therefore, a charging capability of the second pixel is increased, and display quality of the liquid crystal display panel is further raised.

FIG. 9 is a driving waveform of a purely green frame. Taking a third data line Dm+2 having 12 pixels thereon as an example, t11 to t13 correspondingly represent data voltages of a first and a second blue pixel along the third data line, t13 to t15, correspondingly represent data voltages of a first and a second green pixel in the column, t15 to t17 correspondingly represent data voltages of a first and a second red pixel in the column, t17 to t19 correspondingly represent data voltages of a third and a fourth blue pixel along the third data line, t19 to t21 correspondingly represent data voltages of a third and a fourth green pixel in the column, and t21 to t23 correspondingly represent data voltages of a third and a fourth red pixel in the column.

FIG. 9 only provides a driving waveform of one column of the plurality of pixels, wherein 21 represents data voltages provided externally, i.e. initial data voltages, and 22 represents actual data voltages. Because the voltage of the second green pixel on the data line is not in a state of varying between high and low voltage levels, the second green pixel is lightly loaded driven. That is, with respect to FIG. 4, the second pixel being overloaded driven is changed to being lightly loaded driven. Therefore, a charging capability of the second pixel is increased, and display quality of the liquid crystal display panel is further raised. It can be appreciated that a waveform of a driving signal of the blue pixels is similar to that of the green pixels and the description is omitted here.

It can be appreciated that in another embodiment, the (n+1)th data line is connected to odd rows of an (n+1)th column of the plurality of pixels, and is connected to even rows of the nth column of the plurality of pixels.

For the liquid crystal display panel and the device of the present disclosure, because each data line alternately drives two corresponding columns of pixels, when a frame having a single color is displayed, the data line successively drives two pixels having the same color, causing a second pixel to change from being overloaded to being lightly loaded, increasing a charging capability of the second pixel, lowering power consumption of a source driving chip, and raising display quality of the liquid crystal display panel.

In summary, although the present disclosure has been described with preferred embodiments thereof above, it is not intended to be limited by the foregoing preferred embodiments. Persons skilled in the art can carry out many changes and modifications to the described embodiments without departing from the scope and the spirit of the present disclosure. Therefore, the protection scope of the present disclosure is in accordance with the scope defined by the claims.

What is claimed is:

1. A liquid crystal display panel, comprising:
N-numbered data lines;
a plurality of scan lines; and
a plurality of pixels;
wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, and the (n+1)th data line successively drives two of the plurality of pixels having the same color; and
wherein when the liquid crystal display panel displays a frame having a single color, data voltages of the pixels in each column of the plurality of pixels having the same color are configured as a high voltage level, wherein N≥2, and 0<n<N.

2. The liquid crystal display panel of claim 1, wherein the (n+1)th data line is connected to even rows of an (n+1)th column of the plurality of pixels, and is connected to odd rows of the nth column of the plurality of pixels.

3. The liquid crystal display panel of claim 1, wherein the (n+1)th data line is connected to odd rows of an (n+1)th column of the plurality of pixels, and is connected to even rows of the nth column of the plurality of pixels.

4. The liquid crystal display panel of claim 1, wherein the (n+1)th data line successively drives the two of the plurality of pixels having the same color correspondingly in the nth column of the plurality of pixels and an (n+1)th column of the plurality of pixels.

5. The liquid crystal display panel of claim 1, wherein the two of the plurality of pixels having the same color are correspondingly located in two rows of the plurality of pixels adjacent to each other.

6. A liquid crystal display panel, comprising:
N-numbered data lines;
a plurality of scan lines; and
a plurality of pixels;
wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, wherein N≥2, and 0<n<N.

7. The liquid crystal display panel of claim 6, wherein the (n+1)th data line is connected to even rows of an (n+1)th column of the plurality of pixels, and is connected to odd rows of the nth column of the plurality of pixels.

8. The liquid crystal display panel of claim 6, wherein the (n+1)th data line is connected to odd rows of an (n+1)th column of the plurality of pixels, and is connected to even rows of the nth column of the plurality of pixels.

9. The liquid crystal display panel of claim 6, wherein the (n+1)th data line successively drives two of the plurality of pixels having the same color.

10. The liquid crystal display panel of claim 9, wherein the (n+1)th data line successively drives the two of the plurality of pixels having the same color correspondingly in the nth column of the plurality of pixels and an (n+1)th column of the plurality of pixels.

11. The liquid crystal display panel of claim 9, wherein the two of the plurality of pixels having the same color are correspondingly located in two rows of the plurality of pixels adjacent to each other.

12. The liquid crystal display panel of claim 6, wherein when the liquid crystal display panel displays a frame having a single color, data voltages of the pixels in each column of the plurality of pixels having the same color are configured as a high voltage level.

13. A liquid crystal display device, comprising:
a backlight module; and
a liquid crystal display panel, comprising:
N-numbered data lines, a plurality of scan lines, and a plurality of pixels, wherein two of the plurality of pixels adjacent to each other have different colors; wherein each of the plurality of scan lines is correspondingly disposed in each row of the plurality of pixels, an nth column of the plurality of pixels corresponds to an nth data line and an (n+1)th data line, the nth data line and the (n+1)th data line are alternately connected to pixels in the nth column of the plurality of pixels, wherein N≥2, and 0<n<N.

14. The liquid crystal display panel of claim 13, wherein the (n+1)th data line is connected to even rows of an (n+1)th column of the plurality of pixels, and is connected to odd rows of the nth column of the plurality of pixels.

15. The liquid crystal display panel of claim 13, wherein the (n+1)th data line is connected to odd rows of an (n+1)th column of the plurality of pixels, and is connected to even rows of the nth column of the plurality of pixels.

16. The liquid crystal display panel of claim 13, wherein the (n+1)th data line successively drives two of the plurality of pixels having the same color.

17. The liquid crystal display panel of claim 16, wherein the (n+1)th data line successively drives the two of the plurality of pixels having the same color correspondingly in the nth column of the plurality of pixels and an (n+1)th column of the plurality of pixels.

18. The liquid crystal display panel of claim 16, wherein the two of the plurality of pixels having the same color are correspondingly located in two rows of the plurality of pixels adjacent to each other.

19. The liquid crystal display panel of claim 13, wherein when the liquid crystal display panel displays a frame having a single color, data voltages of the pixels in each column of the plurality of pixels having the same color are configured as a high voltage level.
